(19) United States
(12) Patent Application Publication
(10) Pub. No.: US 2025/0199490 A1
(43) Pub. Date: Jun. 19, 2025

(54) SYSTEMS AND METHODS FOR ALTERING OPERATION OF MACHINERY

(71) Applicant: Boston Dynamics, Inc., Waltham, MA (US)

(72) Inventor: Federico Vicentini, Lexington, MA (US)

(21) Appl. No.: 18/541,355

(22) Filed: Dec. 15, 2023

(51) Int. Cl. G05B 15/02

(52) U.S. Cl. CPC G05B 15/02

(57) ABSTRACT

Systems and methods are disclosed for altering operation of a machine (e.g., bringing about an emergency stop). A device comprises an emitter configured to produce a first acoustic signal having a first tone and a second tone, wherein the first tone is different from the second tone. The device also includes an activation mechanism in communication with the emitter. The activation mechanism is configured to activate the emitter.

### TECHNICAL FIELD

This disclosure relates generally to machine safety and more specifically to systems and methods for altering (e.g., interrupting) operation of machinery (e.g., in an emergency).

### BACKGROUND

Many machines pose risks to nearby people and/or property during operation. For example, many automated or semi-automated machines, such as industrial equipment, vehicles, and robots, include heavy and/or fast moving parts that may not always move as intended, creating risks of accidental collisions, electric shocks, or other harms. One means of mitigating such risks is an emergency stop (and/or “protective stop”) mechanism. An emergency stop mechanism is a safety feature (e.g., a switch, button, and/or associated electrical circuit) used to shut off machinery quickly in an emergency (e.g., outside the machine's normal means of powering down, which may be referred to as an “operational stop”). Many machines include emergency stop features, such as manufacturing equipment, autonomous vehicles, and other mobile machines.

Robots are one exemplary type of machine that may pose hazards to nearby people and/or property in certain scenarios. A robot may include a reprogrammable and/or multifunctional manipulator designed to move material, parts, tools, and/or specialized devices through variable programmed motions to perform one or more tasks. Robots may include manipulators that are physically anchored (e.g., industrial robotic arms), mobile platforms that move throughout an environment (e.g., using legs, wheels, or traction-based mechanisms), or some combination of one or more manipulators and/or one or more mobile platforms. Robots are utilized alongside nearby people in a variety of industries, including, for example, manufacturing, warehouse logistics, transportation, hazardous environments, exploration, and healthcare.

### SUMMARY

Systems and methods are provided to reduce risk associated with operation of machines, such as mobile robots or vehicles, by altering (e.g., interrupting) their operation using one or more acoustic (e.g., ultrasonic) signals. In one illustrative embodiment, a machine is mounted with a receiver (e.g., an ultrasonic receiver) that is tuned to a particular frequency (or narrow range of frequencies within a specified band). A device having an emitter (e.g., a separate device situated remotely from the receiver) generates an acoustic signal (e.g., when acted upon by a human). The acoustic signal includes a set of tones. When the receiver detects one or more specific tones (e.g., a signature comprising two or three tones), operation of the machine is altered (e.g., the machine is stopped, such as by an electronic circuit operating to latch an input state of the machine to a powerless state, until the machine is manually reset by further deliberate action of a human being).

In one aspect, the invention features a device comprising an emitter configured to produce a first acoustic signal having a first tone and a second tone. The first tone is different (e.g., in frequency) from the second tone. The first acoustic signal is operable to alter operation of a machine receiving the first acoustic signal. The device comprises an activation mechanism in communication with the emitter. The activation mechanism is configured to activate the emitter.

In some embodiments, the device is located remotely from the machine. In some embodiments, altering operation of the machine comprises interrupting operation of the machine (e.g., in an emergency). In some embodiments, altering operation of the machine comprises stopping and/or starting operation of the machine (e.g., in an emergency). In some embodiments, altering operation of the machine comprises initiating an emergency stop of the machine. In some embodiments, altering operation of the machine comprises electrically separating from the machine one or more sources of power to the machine. In some embodiments, altering operation of the machine comprises stopping motion of the machine (e.g., either temporarily or indefinitely, until human intervention).

In some embodiments, the first acoustic signal is configured to propagate in a fluid medium. In some embodiments, the first acoustic signal is a functional signal. In some embodiments, the first tone has a frequency between 20 kilohertz (kHz) and 2000 kHz (optionally 20 kHz-200 kHz, optionally 20 kHz-1000 kHz, optionally 100 kHz-1000 kHz, etc.). In some embodiments, the second tone has a frequency between 20 kHz and 2000 kHz (optionally 20 kHz-200 kHz, optionally 20 kHz-1000 kHz, optionally 100 kHz-1000 kHz, etc.). In some embodiments, the first tone and the second tone collectively comprise a distinct signature of the machine. In some embodiments, the first tone and the second tone collectively comprise a distinct signature of an objective to be performed by the machine.

In some embodiments, the emitter is configured to produce a second acoustic signal having a third tone. In some embodiments, the second acoustic signal is a control signal. In some embodiments, the third tone has a frequency between 300 Hz and 20 kHz (e.g., a tone that is audible by a human, to confirm for the operator that the device is emitting functional signals that are otherwise not audible). Accordingly, in some embodiments, the third tone is in the audio frequency range (typically audible by humans) while the first tone and the second tone are in the ultrasonic frequency range (typically inaudible by humans). In some embodiments, the emitter comprises a speaker. In some embodiments, the emitter comprises an acoustic vibrator. In some embodiments, emitter comprises an air chamber having an opening. In some embodiments, the emitter comprises a hollow body portion having a fluid inlet and a fluid outlet.

In some embodiments, the device comprises a flow sensor. In some embodiments, the device comprises one or more indicator lights. In some embodiments, the machine comprises a robot. In some embodiments, the machine comprises a vehicle (e.g., mobile, driverless vehicle or equipment). In some embodiments, the machine comprises industrial equipment. In some embodiments, the activation mechanism comprises a blow mechanical feature (e.g., to produce the first acoustic signal via direct human action). In some embodiments, the activation mechanism comprises a blow electromechanical feature (e.g., to produce the first acoustic signal from one or more powered actuators). In some embodiments, the activation mechanism comprises a pull cord and/or a push button (e.g., latched to actuate the blow electromechanical feature).

In some embodiments, the first (and/or second) acoustic signal spans at least 1 second. In some embodiments, the first (and/or second) tone is a solid tone. In some embodiments, the device is configured to be handheld. In some embodiments, the device is configured to be attached to a garment. In some embodiments, the first acoustic signal is a periodic signal. In some embodiments, the device further comprises a receiver configured to receive a return signal from the machine. In some embodiments, the return signal comprises a periodic control signal, a pairing signal (e.g., produced automatically, repeatedly or based on pairing events, from the machine), and/or an acknowledgement signal (e.g., produced by deliberate action on the machine by a human).

In some embodiments, the device is configured to determine a proximity of the machine based on a loss of magnitude of the return signal relative to a specified origination power of the return signal. In some embodiments, the device is battery powered. In some embodiments, the device is configured to alter operation of two or more machines. In some embodiments, the device is configured to alter operation of one uniquely identified machine. In some embodiments, the device is embodied in a remote control device of the machine. In some embodiments, the machine is configured to be altered based on a location of the machine relative to the device (e.g., the machine can be configured to receive an emitted signal based on external devices associated with the location of interest, and when the machine enters these regions, the signal can be configured to be ignored or received and processed only inside the defined region).

In some embodiments, the device further comprises a signal processor configured to determine a nominal frequency of the first tone. In some embodiments, the first acoustic signal comprises two or more single solid tones (e.g., within a band around the nominal frequency). In some embodiments, the nominal frequency of the first tone can be determined within a configurable tolerance (e.g., user-selectable tolerance). In some embodiments, the signal processor is configured to determine an intensity of a received signal with respect to a sound power of the first acoustic signal. In some embodiments, the device further comprises a controller configured to regulate a frequency and/or an amplitude of the first acoustic signal. (In some embodiments, the frequency and/or amplitude of the signals to be emitted can be configured and stored in the internal memory of the device.)

In another aspect, the invention features a device for altering operation of a machine. The device comprises a receiver configured to recognize a first acoustic signal having a first tone and a second tone. The first tone is different (e.g., in frequency) from the second tone. The device comprises a controller in communication with the receiver. The controller is configured to alter operation of the machine based on the first acoustic signal.

In some embodiments, alteration of operation of the machine based on the first acoustic signal is maintained until the device receives separate action. In some embodiments, the separate action comprises receiving a second acoustic signal having a third tone and a fourth tone, at least one of the first tone or the second tone different (e.g., in frequency) from at least one of the third tone or the fourth tone. In some embodiments, the first tone, the second tone, the third tone, and the fourth tone are each of a different frequency. In some embodiments, the separate action comprises physical actuation of a component configured for interaction with an operator. In some embodiments, the device is attached to the machine. In some embodiments, altering operation of the machine comprises interrupting operation of the machine. In some embodiments, altering operation of the machine comprises stopping and/or starting operation of the machine. In some embodiments, altering operation of the machine comprises initiating an emergency stop of the machine. In some embodiments, altering operation of the machine comprises electrically separating from the machine one or more sources of power to the machine. In some embodiments, altering operation of the machine comprises stopping motion of the machine (e.g., either temporarily or indefinitely, until human intervention).

In some embodiments, the first acoustic signal is configured to propagate in a fluid medium. In some embodiments, the first acoustic signal is a functional signal. In some embodiments, the first tone has a frequency between 20 kHz and 2000 kHz (optionally 20 kHz-200 kHz, optionally 20 kHz-1000 kHz, optionally 100 kHz-1000 kHz, etc.). In some embodiments, the second tone has a frequency between 20 kHz and 2000 kHz (optionally 20 kHz-200 kHz, optionally 20 kHz-1000 kHz, optionally 100 kHz-1000 kHz, etc.). In some embodiments, the first tone and the second tone collectively comprise a distinct signature of the machine. In some embodiments, the first tone and the second tone collectively comprise a distinct signature of an objective to be performed by the machine.

In some embodiments, the machine comprises a robot. In some embodiments, the machine comprises a vehicle (e.g., mobile, driverless vehicle or equipment). In some embodiments, the machine comprises industrial equipment. In some embodiments, the first (and/or second) tone is a solid tone. In some embodiments, the first acoustic signal is a periodic signal. In some embodiments, the device further comprises an emitter configured to generate a return signal. In some embodiments, the return signal comprises a periodic control signal, a pairing signal (e.g., produced automatically, repeatedly or based on pairing events, from the machine), or an acknowledgement signal (e.g., produced by deliberate action on the machine by a human).

In some embodiments, the device is battery powered. In some embodiments, the device is configured to alter operation of one uniquely identified machine. In some embodiments, the first acoustic signal comprises two or more single solid tones (e.g., in a narrow band around a nominal frequency). In some embodiments, the device further comprises a signal processor configured to determine a nominal frequency of the first tone. In some embodiments, the nominal frequency of the first tone can be determined within a configurable tolerance. In some embodiments, the signal processor is configured to determine an intensity of a received signal with respect to a sound power of the first acoustic signal.

In another aspect, the invention features a method of altering operation of a machine. The method comprises receiving, by an activation mechanism of a device, an actuation action. The method comprises emitting, by an emitter in communication with the activation mechanism, a first acoustic signal having a first tone and a second tone, the first tone different from the second tone.

In some embodiments, the device is located remotely from the machine. In some embodiments, altering operation of the machine comprises interrupting operation of the machine. In some embodiments, altering operation of the machine comprises stopping and/or starting operation of the machine. In some embodiments, altering operation of the machine comprises initiating an emergency stop of the machine. In some embodiments, altering operation of the machine comprises electrically separating from the machine one or more sources of power to the machine. In some embodiments, altering operation of the machine comprises stopping motion of the machine (e.g., either temporarily or indefinitely, until human intervention).

In some embodiments, the first acoustic signal is configured to propagate in a fluid medium. In some embodiments, the first acoustic signal is a functional signal. In some embodiments, the first tone has a frequency between 20 kHz and 2000 kHz (optionally 20 kHz-200 kHz, optionally 20 kHz-1000 kHz, optionally 100 kHz-1000 kHz, etc.). In some embodiments, the second tone has a frequency between 20 kHz and 2000 kHz (optionally 20 kHz-200 kHz, optionally 20 kHz-1000 kHz, optionally 100 kHz-1000 kHz, etc.).

In some embodiments, the first tone and the second tone collectively comprise a distinct signature of the machine. In some embodiments, the first tone and the second tone collectively comprise a distinct signature of an objective to be performed by the machine. In some embodiments, the emitter is configured to produce a second acoustic signal having a third tone. In some embodiments, the second acoustic signal is a control signal. In some embodiments, the third tone has a frequency between 300 Hz and 20 kHz (e.g., audible by a human, to confirm for the operator that the device is emitting functional signals that are otherwise not audible).

In some embodiments, the emitter comprises a speaker. In some embodiments, the emitter comprises an acoustic vibrator. In some embodiments, the emitter comprises an air chamber having an opening. In some embodiments, the emitter comprises a hollow body portion having a fluid inlet and a fluid outlet. In some embodiments, the device comprises a flow sensor. In some embodiments, the device comprises one or more indicator lights.

In some embodiments, the machine comprises a robot. In some embodiments, the machine comprises a vehicle (e.g., mobile, driverless vehicle or equipment). In some embodiments, the machine comprises industrial equipment. In some embodiments, the activation mechanism comprises a blow mechanical feature (e.g., to produce a signal from direct human action). In some embodiments, the activation mechanism comprises a blow electromechanical feature (e.g., to produce a signal from one or more powered actuators). In some embodiments, the activation mechanism comprises a pull cord and/or a push button (e.g., latched to actuate the electromechanical feature).

In some embodiments, the first (and/or second) acoustic signal spans at least 1 second. In some embodiments, the first (and/or second) tone is a solid tone. In some embodiments, the device is configured to be handheld. In some embodiments, the device is configured to be attached to a garment. In some embodiments, the first acoustic signal is a periodic signal. In some embodiments, the device is embodied in a remote control device of the machine.

In another aspect, the invention features a method of altering operation of a machine. The method comprises receiving, by a receiver, a first acoustic signal having a first tone and a second tone, the first tone different from the second tone. The method comprises generating, by a controller in communication with the receiver, a command to alter operation of a machine based on the first acoustic signal.

In some embodiments, the first acoustic signal is received from a device located remotely from the machine. In some embodiments, altering operation of the machine comprises interrupting operation of the machine. In some embodiments, altering operation of the machine comprises stopping and/or starting operation of the machine. In some embodiments, altering operation of the machine comprises initiating an emergency stop of the machine. In some embodiments, altering operation of the machine comprises electrically separating from the machine one or more sources of power to the machine. In some embodiments, altering operation of the machine comprises stopping motion of the machine (e.g., either temporarily or indefinitely, until human intervention).

In some embodiments, the first acoustic signal is configured to propagate in a fluid medium. In some embodiments, the first acoustic signal is a functional signal. In some embodiments, the first tone has a frequency between 20 kHz and 2000 kHz (optionally 20 kHz-200 kHz, optionally 20 kHz-1000 kHz, optionally 100 kHz-1000 kHz, etc.). In some embodiments, the second tone has a frequency between 20 kHz and 2000 kHz (optionally 20 kHz-200 kHz, optionally 20 kHz-1000 kHz, optionally 100 kHz-1000 kHz, etc.).

In some embodiments, the first tone and the second tone collectively comprise a distinct signature of the machine. In some embodiments, the first tone and the second tone collectively comprise a distinct signature of an objective to be performed by the machine. In some embodiments, the machine comprises a robot. In some embodiments, the machine comprises a vehicle (e.g., mobile, driverless vehicle or equipment). In some embodiments, the machine comprises industrial equipment. In some embodiments, the first (and/or second) acoustic signal spans at least 1 second. In some embodiments, the first (and/or second) tone is a solid tone. In some embodiments, the first acoustic signal is a periodic signal.

In another aspect, the invention features a system for altering operation of a machine. The system comprises a first device for altering operation of a machine. The first device comprises an emitter configured to produce a first acoustic signal having a first tone and a second tone. The first tone is different from the second tone. The system comprises an activation mechanism in communication with the emitter. The activation mechanism is configured to activate the emitter. The system comprises a second device for altering operation of the machine. The second device comprises a receiver configured to recognize the first acoustic signal. The second device comprises a controller in communication with the receiver. The controller is configured to alter operation of the machine based on the first acoustic signal. In some embodiments, the system comprises one or more relay units configured to propagate the first acoustic signal over an increased range relative to a configuration in which the second device receives the first acoustic signal directly from the first device.

In some embodiments, a set of portable emitting devices, each capable of generating an acoustic signal with a similar set of tones, can be distributed to personnel that may potentially exposed to the dangerous machine(s). In some embodiments, the set of tones is made unique (e.g., by selecting a sufficiently distinctive frequency or combination of frequencies) to avoid false positive actuations. In some embodiments, during an emergency, a person can trigger an emergency stop by performing a single action (e.g., blowing a whistle, pulling a cord, or pushing a button, as shown in the figures and described below). In some embodiments, the emergency signal can be broadcasted by any number of emitters without explicit pairing with corresponding receivers. In some embodiments, one or more receivers can continuously (and/or periodically, with a sufficiently small period) be “listening” for relevant tone(s), thereby reducing the complexity of the system.

In some embodiments, the device produces one or more audible tones (e.g., to confirm to the operator that the device is working). In some embodiments, the device comprises a receiver, which can be tuned to a particular frequency to detect when a target machine is in range. In some embodiments, when the device effects an emergency stop of the target machine(s), the human-activated device is not latched, as in certain conventional devices (e.g., mushroom buttons, pedals, or cords). In some embodiments, latching of a command (e.g., which prevents the machine(s) from restarting after generating the acoustic signal) is implemented on the machine, reducing the complexity of the device (e.g., the emergency stop actuator device).

Embodiments of the described systems and methods can be made simple and robust, enabling substantial scalability. In some embodiments, ultrasound signals can provide an omnipresent, permanent medium for signal transport (e.g., in nearly all environments except for vacuum) and derive from a reliable physical principle on which to operate. In some embodiments, simplicity and reliability are increased by not relying on a continuously sustained (e.g., RF or other powered), protocol-dependent, and/or pairing-required wireless connection between the receiver and the device. In some embodiments, there is no limit on the number of devices associated with a given set of tones (e.g., because the receiver(s) are agnostic about the source of the tones). In some embodiments, the required acoustic channel(s) have very little overhead for access to the transport layer (e.g., compared to RF protocols). For example, the receiver can be comprised of acoustic sensors and/or tuners, with no need for antennas and/or access to potentially regulated frequencies or channels subject to RF interference.

In some embodiments, a signal does not need to be explicitly acknowledged (e.g., with a returned confirmation signal) to the emitting machine, allowing for simple implementation of a broadcasting solution instead of a point-to-point wireless interface (e.g., where the carrier must be sustained). In some embodiments, one or more components of the disclosed system can be used to detect a proximity of the machine to the device. In some embodiments, ultrasonic signals broadcast by a mobile machine, such as a robot or a vehicle, can be used as a status broadcast mechanism for nearby (e.g., approaching) machinery. In some embodiments, a direction and/or a magnitude of the ultrasonic signal can vary depending on the orientation of sensors associated with the devices and/or receivers. In some embodiments, a span of control of the device is highly scalable (e.g., by using a mesh of sound-relaying units to extend the propagation of one or more signals or tones throughout an area, without the need to log into a RF network) and/or divided into zones (e.g., aisles of a warehouse). In some embodiments, the ultrasonic signal can be used to determine the presence of (e.g., track, localize, etc.) one or more robots at one or more moments in time (e.g., by determining that the one or more robots are within a certain distance of the emitter).

### BRIEF DESCRIPTION OF DRAWINGS

The advantages of the invention, together with further advantages, may be better understood by referring to the following description taken in conjunction with the accompanying drawings. The drawings are not necessarily to scale, and emphasis is instead generally placed upon illustrating the principles of the invention.

FIG. 1A illustrates an example configuration of a robotic device, according to an illustrative embodiment.

FIG. 1B illustrates an example configuration of a quadruped robot, according to an illustrative embodiment.

FIG. 2 illustrates a perspective view of a quadruped robot, according to another illustrative embodiment.

FIG. 3 illustrates a perspective view of a biped robot, according to an illustrative embodiment.

FIG. 4A schematically illustrates an operator using a device to alter (e.g., interrupt) operation of a machine, according to an illustrative embodiment.

FIG. 4B schematically illustrates an operator using a device to alter (e.g., interrupt) operation of multiple machines, according to an illustrative embodiment.

FIG. 5 illustrates a schematic of a first device for altering operation of a machine (remote from the machine) and a second device for altering operation of a machine (mounted to the machine), according to an illustrative embodiment.

FIGS. 6A-6D illustrate schematics of four devices for altering operation of a machine, each having different actuation mechanisms, according to illustrative embodiments.

FIG. 7 illustrates a schematic of an exemplary device for altering operation of a machine, according to an illustrative embodiment.

FIGS. 8A-8B schematically illustrate exemplary signals produced by a device for altering operation of a machine, according to an illustrative embodiment.

FIG. 9 schematically illustrates a unique signature carried by a signal produced by a device for altering operation of a machine, according to an illustrative embodiment.

FIG. 10A is a flowchart of an exemplary method for altering operation of a machine, according to an illustrative embodiment.

FIG. 10B is a flowchart of an exemplary method for altering operation of a machine, according to an illustrative embodiment.

FIGS. 11A and 11B are perspective views of a robot, according to an illustrative embodiment of the invention.

### DETAILED DESCRIPTION

In this disclosure, a “tone” may include a loudness and a sound pitch. A “band” may include a range of sound frequencies for one or more tones (e.g., an ultrasound band). A “functional signal” can include one or more tones in a band (e.g., an ultrasonic band), and a “control signal” can includes one or more tones in a different band (e.g., an audible band). A “signature” can include a unique combination of two or more non-resonant tones (e.g., in a band). A “span of control” may refer to (i) a set of machines (or a part of the machine, or one or more machines in a fleet of machines) configured to respond to a particular functional signal, e.g., within a certain range of distance, or associated with a certain signature or set of signatures.

An example implementation involves a robotic device configured with at least one robotic limb, one or more sensors, and a processing system. The robotic limb may be an articulated robotic appendage including a number of members connected by joints. The robotic limb may also include a number of actuators (e.g., 2-5 actuators) coupled to the members of the limb that facilitate movement of the robotic limb through a range of motion limited by the joints connecting the members. The sensors may be configured to measure properties of the robotic device, such as angles of the joints, pressures within the actuators, joint torques, and/or positions, velocities, and/or accelerations of members of the robotic limb(s) at a given point in time. The sensors may also be configured to measure an orientation (e.g., a body orientation measurement) of the body of the robotic device (which may also be referred to herein as the “base” of the robotic device). Other example properties include the masses of various components of the robotic device, among other properties. The processing system of the robotic device may determine motions or other parameters of the robotic device, e.g., the angles of the joints of the robotic limb (either directly from angle sensor information or indirectly from other sensor information from which the joint angles can be calculated).

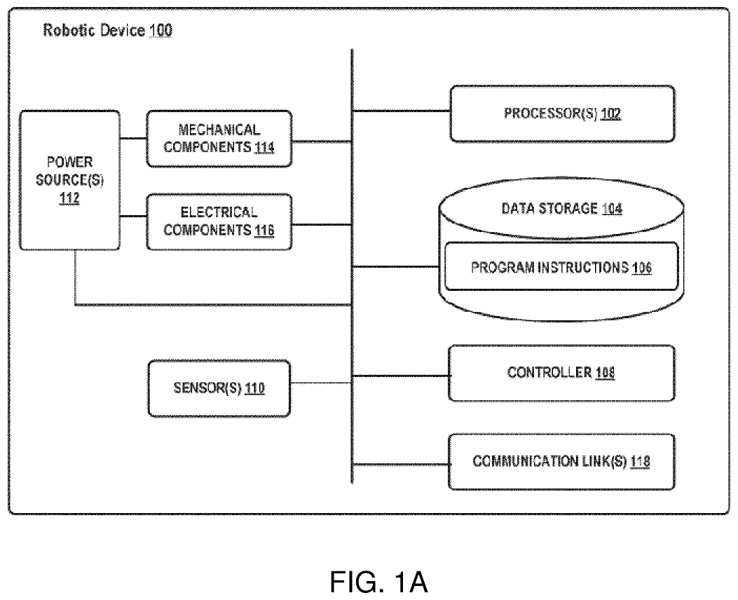

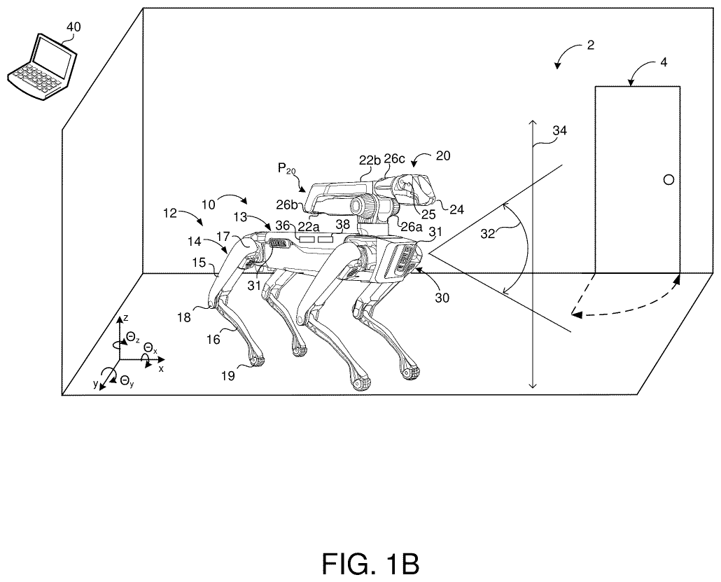

FIG. 1A illustrates an example configuration of a robotic device (or “robot”) 100, according to an illustrative embodiment. The robotic device 100 represents an example robotic device configured to perform the operations described herein. Additionally, the robotic device 100 may be configured to operate autonomously, semi-autonomously, and/or using directions provided by user(s), and may exist in various forms, such as a humanoid robot, biped, quadruped, or other mobile robot, among other examples. Furthermore, the robotic device 100 may also be referred to as a robotic system, mobile robot, or robot, among other designations.

As shown in FIG. 1A, the robotic device 100 includes processor(s) 102, data storage 104, program instructions 106, controller 108, sensor(s) 110, power source(s) 112, mechanical components 114, and electrical components 116. The robotic device 100 is shown for illustration purposes and may include more or fewer components without departing from the scope of the disclosure herein. The various components of robotic device 100 may be connected in any manner, including via electronic communication means, e.g., wired or wireless connections. Further, in some examples, components of the robotic device 100 may be positioned on multiple distinct physical entities rather on a single physical entity. Other example illustrations of robotic device 100 may exist as well.

Processor(s) 102 may operate as one or more general-purpose processor or special purpose processors (e.g., digital signal processors, application specific integrated circuits, etc.). The processor(s) 102 can be configured to execute computer-readable program instructions 106 that are stored in the data storage 104 and are executable to provide the operations of the robotic device 100 described herein. For instance, the program instructions 106 may be executable to provide operations of controller 108, where the controller 108 may be configured to cause activation and/or deactivation of the mechanical components 114 and the electrical components 116. The processor(s) 102 may operate and enable the robotic device 100 to perform various functions, including the functions described herein.

The data storage 104 may exist as various types of storage media, such as a memory. For example, the data storage 104 may include or take the form of one or more computer-readable storage media that can be read or accessed by processor(s) 102. The one or more computer-readable storage media can include volatile and/or non-volatile storage components, such as optical, magnetic, organic or other memory or disc storage, which can be integrated in whole or in part with processor(s) 102. In some implementations, the data storage 104 can be implemented using a single physical device (e.g., one optical, magnetic, organic or other memory or disc storage unit), while in other implementations, the data storage 104 can be implemented using two or more physical devices, which may communicate electronically (e.g., via wired or wireless communication). Further, in addition to the computer-readable program instructions 106, the data storage 104 may include additional data such as diagnostic data, among other possibilities.

The robotic device 100 may include at least one controller 108, which may interface with the robotic device 100. The controller 108 may serve as a link between portions of the robotic device 100, such as a link between mechanical components 114 and/or electrical components 116. In some instances, the controller 108 may serve as an interface between the robotic device 100 and another computing device. Furthermore, the controller 108 may serve as an interface between the robotic system 100 and a user(s). The controller 108 may include various components for communicating with the robotic device 100, including one or more joysticks or buttons, among other features. The controller 108 may perform other operations for the robotic device 100 as well. Other examples of controllers may exist as well.

Additionally, the robotic device 100 includes one or more sensor(s) 110 such as force sensors, proximity sensors, motion sensors, load sensors, position sensors, touch sensors, depth sensors, ultrasonic range sensors, and/or infrared sensors, among other possibilities. The sensor(s) 110 may provide sensor data to the processor(s) 102 to allow for appropriate interaction of the robotic system 100 with the environment as well as monitoring of operation of the systems of the robotic device 100. The sensor data may be used in evaluation of various factors for activation and deactivation of mechanical components 114 and electrical components 116 by controller 108 and/or a computing system of the robotic device 100.

The sensor(s) 110 may provide information indicative of the environment of the robotic device for the controller 108 and/or computing system to use to determine operations for the robotic device 100. For example, the sensor(s) 110 may capture data corresponding to the terrain of the environment or location of nearby objects, which may assist with environment recognition and navigation, etc. In an example configuration, the robotic device 100 may include a sensor system that may include a camera, RADAR, LIDAR, time-of-flight camera, global positioning system (GPS) transceiver, and/or other sensors for capturing information of the environment of the robotic device 100. The sensor(s) 110 may monitor the environment in real-time and detect obstacles, elements of the terrain, weather conditions, temperature, and/or other parameters of the environment for the robotic device 100.

Further, the robotic device 100 may include other sensor(s) 110 configured to receive information indicative of the state of the robotic device 100, including sensor(s) 110 that may monitor the state of the various components of the robotic device 100. The sensor(s) 110 may measure activity of systems of the robotic device 100 and receive information based on the operation of the various features of the robotic device 100, such the operation of extendable legs, arms, or other mechanical and/or electrical features of the robotic device 100. The sensor data provided by the sensors may enable the computing system of the robotic device 100 to determine errors in operation as well as monitor overall functioning of components of the robotic device 100.

For example, the computing system may use sensor data to determine the stability of the robotic device 100 during operations as well as measurements related to power levels, communication activities, components that require repair, among other information. As an example configuration, the robotic device 100 may include gyroscope(s), accelerometer(s), and/or other possible sensors to provide sensor data relating to the state of operation of the robotic device. Further, sensor(s) 110 may also monitor the current state of a function, such as a gait, that the robotic system 100 may currently be operating. Additionally, the sensor(s) 110 may measure a distance between a given robotic leg of a robotic device and a center of mass of the robotic device. Other example uses for the sensor(s) 110 may exist as well.

Additionally, the robotic device 100 may also include one or more power source(s) 112 configured to supply power to various components of the robotic device 100. Among possible power systems, the robotic device 100 may include a hydraulic system, electrical system, batteries, and/or other types of power systems. As an example illustration, the robotic device 100 may include one or more batteries configured to provide power to components via a wired and/or wireless connection. Within examples, components of the mechanical components 114 and electrical components 116 may each connect to a different power source or may be powered by the same power source. Components of the robotic system 100 may connect to multiple power sources as well.

Within example configurations, any type of power source may be used to power the robotic device 100, such as a gasoline and/or electric engine. Further, the power source(s) 112 may charge using various types of charging, such as wired connections to an outside power source, wireless charging, combustion, or other examples. Other configurations may also be possible. Additionally, the robotic device 100 may include a hydraulic system configured to provide power to the mechanical components 114 using fluid power. Components of the robotic device 100 may operate based on hydraulic fluid being transmitted throughout the hydraulic system to various hydraulic motors and hydraulic cylinders, for example. The hydraulic system of the robotic device 100 may transfer a large amount of power through small tubes, flexible hoses, or other links between components of the robotic device 100. Other power sources may be included within the robotic device 100 (e.g., electric components, such as electric motors and/or gearboxes may be used in place of or in addition to hydraulic components).

Mechanical components 114 can represent hardware of the robotic system 100 that may enable the robotic device 100 to operate and perform physical functions. As a few examples, the robotic device 100 may include actuator(s), extendable leg(s) (“legs”), arm(s), wheel(s), one or multiple structured bodies for housing the computing system or other components, and/or other mechanical components. The mechanical components 114 may depend on the design of the robotic device 100 and may also be based on the functions and/or tasks the robotic device 100 may be configured to perform. As such, depending on the operation and functions of the robotic device 100, different mechanical components 114 may be available for the robotic device 100 to utilize. In some examples, the robotic device 100 may be configured to add and/or remove mechanical components 114, which may involve assistance from a user and/or other robotic device. For example, the robotic device 100 may be initially configured with four legs, but may be altered by a user or the robotic device 100 to remove two of the four legs to operate as a biped. Other examples of mechanical components 114 may be included.

The electrical components 116 may include various components capable of processing, transferring, providing electrical charge or electric signals, for example. Among possible examples, the electrical components 116 may include electrical wires, circuitry, and/or wireless communication transmitters and receivers to enable operations of the robotic device 100. The electrical components 116 may interwork with the mechanical components 114 to enable the robotic device 100 to perform various operations. The electrical components 116 may be configured to provide power from the power source(s) 112 to the various mechanical components 114, for example. Further, the robotic device 100 may include electric motors. Other examples of electrical components 116 may exist as well.

In some implementations, the robotic device 100 may also include communication link(s) 118 configured to send and/or receive information. The communication link(s) 118 may transmit data indicating the state of the various components of the robotic device 100. For example, information read in by sensor(s) 110 may be transmitted via the communication link(s) 118 to a separate device. Other diagnostic information indicating the integrity or health of the power source(s) 112, mechanical components 114, electrical components 118, processor(s) 102, data storage 104, and/or controller 108 may be transmitted via the communication link(s) 118 to an external communication device.

In some implementations, the robotic device 100 may receive information at the communication link(s) 118 that is processed by the processor(s) 102. The received information may indicate data that is accessible by the processor(s) 102 during execution of the program instructions 106, for example. Further, the received information may change aspects of the controller 108 that may affect the behavior of the mechanical components 114 or the electrical components 116. In some cases, the received information indicates a query requesting a particular piece of information (e.g., the operational state of one or more of the components of the robotic device 100), and the processor(s) 102 may subsequently transmit that particular piece of information back out the communication link(s) 118.

In some cases, the communication link(s) 118 include a wired connection. The robotic device 100 may include one or more ports to interface the communication link(s) 118 to an external device. The communication link(s) 118 may include, in addition to or alternatively to the wired connection, a wireless connection. Some example wireless connections may utilize a cellular connection, such as CDMA, EVDO, GSM/GPRS, or 4G telecommunication, such as WiMAX or LTE. Alternatively or in addition, the wireless connection may utilize a Wi-Fi connection to transmit data to a wireless local area network (WLAN). In some implementations, the wireless connection may also communicate over an infrared link, radio, Bluetooth, or a near-field communication (NFC) device.

The communication link(s) 118 can also include an acoustic channel that receives acoustic signals processed by a receiver (e.g., an ultrasonic receiver) of the robotic device 100 that is tunable (e.g., by the processor(s) 102) to a particular acoustic frequency or range of acoustic frequencies. For example, a remote device that is external to and separated from the robotic device 100 can include an emitter that generates an acoustic signal that includes a set of tones. When the robotic device's receiver detects one or more specific tones (e.g., a signature comprising two or three tones), operation of the robotic device 100 is altered (e.g., the robotic device 100 is stopped, such as by an electronic circuit of the electronic components 116 operating to disconnect one or more components of the robotic device from the power source(s) 112 to latch the robotic device 100 to a powerless state, until the robotic device 100 manually reset by further deliberate action of a human being).

FIG. 1B illustrates an example configuration of a quadruped robot 10 (also referred to as a robot or robotic device 10), according to an illustrative embodiment. Many robots include multi-axis articulable appendages configured to execute complex movements for completing tasks, such as material handling or industrial operations (e.g., welding, gluing, and/or fastening). These appendages, also referred to as manipulators or arms, typically include an end-effector or hand attached at the end of a series appendage segments or portions, which are connected to each other by one or more appendage joints. The appendage joints cooperate to configure the appendage in a variety of poses within a space associated with the robot. Here, the term “pose” refers to the position and orientation of the appendage. For example, the pose of the appendage may be defined by coordinates (x, y, z) of the appendage within a workspace (for instance, in a Cartesian space), and the orientation may be defined by angles (for instance, Ox, Oy, Oz) of the appendage within the workspace. In use, the appendage may need to manipulate partially constrained objects by applying forces to move the object along or about one or more unconstrained axes.

Referring to FIG. 1B, a robot or robotic device 10 includes a base 12 having a body 13 and two or more legs 14. Each leg 14 may have an upper leg portion 15 and a lower leg portion 16. The upper leg portion 15 may be attached to the body 13 at an upper joint 17 (i.e., a hip joint) and the lower leg portion 16 may be attached to the upper leg portion 15 by an intermediate joint 18 (i.e., a knee joint). Each leg 14 further includes a contact pad or foot 19 disposed at a distal end of the lower leg portion 16, which provides a ground-contacting point for the base 12 of the robot 10.

In some implementations, the robot 10 further includes one or more appendages, such as an articulated arm 20 or manipulator disposed on the body 13 and configured to move relative to the body 13. Moreover, the articulated arm 20 may be interchangeably referred to as a manipulator, an appendage arm, or simply an appendage. In the example shown, the articulated arm 20 includes two arm portions 22a, 22b rotatable relative to one another and the body 13. However, the articulated arm 20 may include more or fewer arm portions without departing from the scope of the present disclosure. A third arm portion 24 of the articulated arm, referred to as an end effector 24, hand 24, or gripper 24, may be interchangeably coupled to a distal end of the second portion 22b of the articulated arm 20 and may include one or more actuators 25 for gripping/grasping objects 4.

The articulated arm 20 includes a plurality of joints 26a-26c disposed between adjacent ones of the arm portions 22a, 22b, 24. In the example shown, the first arm portion 22a is attached to the body 13 of the robot 10 by a first two-axis joint 26a, interchangeably referred to as a shoulder 26a. A single-axis joint 26b connects the first arm portion 22a to the second arm portion 22b. The second joint 26b includes a single axis of rotation and may be interchangeably referred to as an elbow 26b of the articulated arm 20. A second two axis joint 26c connects the second arm portion 22b to the hand 24, and may be interchangeably referred to as a wrist 26c of the articulated arm 20. The articulated arm 20 is moveable between arm poses P₂₀. Additionally, the joints 26a-26c cooperate to provide the articulated arm 20 with five degrees of freedom (i.e., five axes of rotation). While the illustrated example shows a five-axis articulated arm 20, the principles of the present disclosure are applicable to robotic arms having any number of axes. Furthermore, the principles of the present disclosure are applicable to robotic arms mounted to different types of bases, such as mobile bases including one or more wheels or stationary bases.

The robot 10 also includes a vision system 30 with at least one imaging sensor or camera 31, each sensor or camera 31 capturing image data or sensor data of the environment 2 surrounding the robot 10 with an angle of view 32 and within a field of view 34. The vision system 30 may be configured to move the field of view 34 by adjusting the angle of view 32 or by panning and/or tilting (either independently or via movement of the robot 10) the camera 31 to move the field of view 34 in any direction. Alternatively, the vision system 30 may include multiple sensors or cameras 31 such that the vision system 30 captures a generally 360-degree field of view around the robot 10. The camera(s) 31 of the vision system 30, in some implementations, include one or more stereo cameras (e.g., one or more RGBD stereo cameras providing both color (RGB) and depth (D)). In other examples, the vision system 30 includes one or more radar sensors such as a scanning light-detection and ranging (LIDAR) sensor, or a scanning laser-detection and ranging (LADAR) sensor, a light scanner, a time-of-flight sensor, or any other three-dimensional (3D) volumetric image sensor (or any such combination of sensors). The vision system 30 provides image data or sensor data derived from image data captured by the cameras or sensors 31 to the data processing hardware 36 of the robot 10. The data processing hardware 36 is in digital communication with memory hardware 38 and, in some implementations, may be a remote system. The remote system may be a single computer, multiple computers, or a distributed system (e.g., a cloud environment) having scalable/elastic computing resources and/or storage resources.

In the example shown, the robot 10 executes commands from a remote device 40 in communication with the robot 10.

Movements and poses of the robot 10 and robot appendages 14, 20 may be defined in terms of a robot workspace based on a Cartesian coordinate system. In the example of the robot 10 provided in FIG. 1B, the robot workspace may be defined by six dimensions including the translational axes x, y, z and rotational axes Θₓ, Θ_{y}, Θ_{z} (SE(3) manifolds). Actions of the robot 10 and/or the robot arm 20 may be defined using lower-dimensional spaces or manifolds including less axes than the number of axes (six) of the workspace.

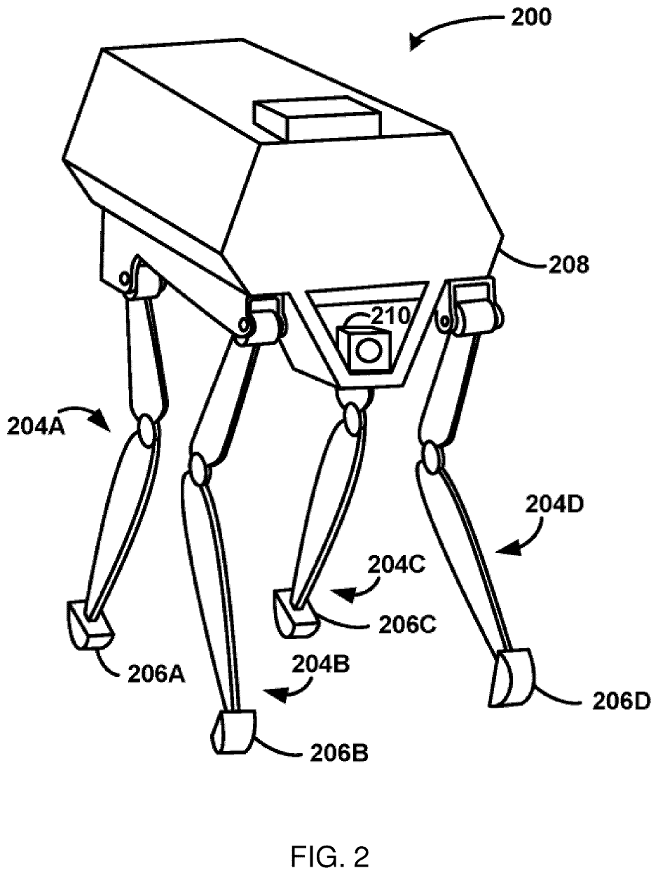

FIG. 2 illustrates a quadruped robot 200, according to another example implementation. Among other possible features, the robot 200 may be configured to perform some of the operations described herein. The robot 200 includes a control system, and legs 204A, 204B, 204C, 204D connected to a body 208. Each leg may include a respective foot 206A, 206B, 206C, 206D that may contact a surface (e.g., a ground surface). Further, the robot 200 is illustrated with sensor(s) 210, and may be capable of carrying a load on the body 208. Within other examples, the robot 200 may include more or fewer components, and thus may include components not shown in FIG. 2.

The robot 200 may be a physical representation of the robotic system 100 shown in FIG. 1A, or may be based on other configurations. Thus, the robot 200 may include one or more of mechanical components 110, sensor(s) 112, power source(s) 114, electrical components 116, and/or control system 118, among other possible components or systems. In addition, the configuration, position, and/or structure of the legs 204A-204D may vary in example implementations. For example, the legs 204A-204D may enable the robot 200 to move relative to its environment, and may be configured to operate in multiple degrees of freedom to enable different techniques of travel. In particular, the legs 204A-204D may enable the robot 200 to travel at various speeds according to the mechanics set forth within different gaits. The robot 200 may use one or more gaits to travel within an environment, which may involve selecting a gait based on speed, terrain, the need to maneuver, and/or energy efficiency.

The body 208 of the robot 200, which may connect to the legs 204A-204D, may house various components of the robot 200. For example, the body 208 may include or carry sensor(s) 210. These sensors may be any of the sensors discussed in the context of sensor(s) 112, such as a camera, LIDAR, or an infrared sensor, but are not limited to those illustrated in FIG. 2. In addition, sensor(s) 210 may be positioned in various locations on the robot 200, such as on the body 208 and/or on one or more of the legs 204A-204D, among other examples.

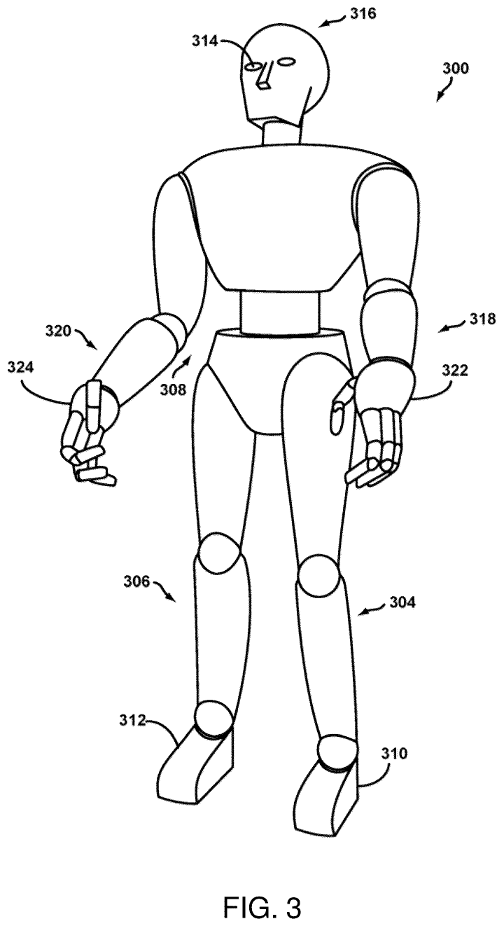

FIG. 3 illustrates a biped robot 300 according to another example implementation. Similar to robot 200, the robot 300 may correspond to the robotic system 100 shown in FIG. 1A, and may be configured to perform some of the implementations described herein. Thus, like the robot 200, the robot 300 may include one or more of mechanical components 110, sensor(s) 112, power source(s) 114, electrical components 116, and/or control system 118.

For example, the robot 300 may include legs 304 and 306 connected to a body 308. Each leg may consist of one or more members connected by joints and configured to operate with various degrees of freedom with respect to one another. Each leg may also include a respective foot 310 and 312, which may contact a surface (e.g., a ground surface). Like the robot 200, the legs 304 and 306 may enable the robot 300 to travel at various speeds according to the mechanics set forth within gaits. The robot 300, however, may utilize different gaits from that of the robot 200, due at least in part to the differences between biped and quadruped capabilities.

The robot 300 may also include arms 318 and 320. These arms may facilitate certain functions for the robot 300, such as object manipulation, load carrying, and/or balancing. Like legs 304 and 306, each arm may consist of one or more members connected by joints and configured to operate with various degrees of freedom with respect to one another. Each arm may also include a respective hand 322 and 324. The robot 300 may use hands 322 and 324 for gripping, turning, pulling, and/or pushing objects. The hands 322 and 324 may include various types of appendages or attachments, such as fingers, grippers, welding tools, cutting tools, and so on.

The robot 300 may also include sensor(s) 314, corresponding to sensor(s) 112, and configured to provide sensor data to its control system. In some cases, the locations of these sensors may be chosen in order to suggest an anthropomorphic structure of the robot 300. Thus, as illustrated in FIG. 3, the robot 300 may contain vision sensors (e.g., cameras, infrared sensors, object sensors, range sensors, etc.) within its head 316.

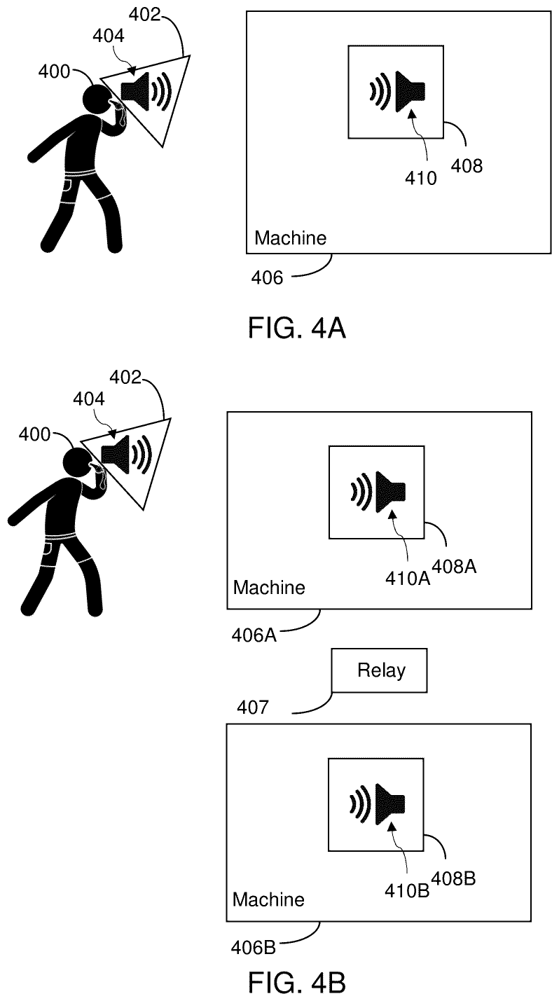

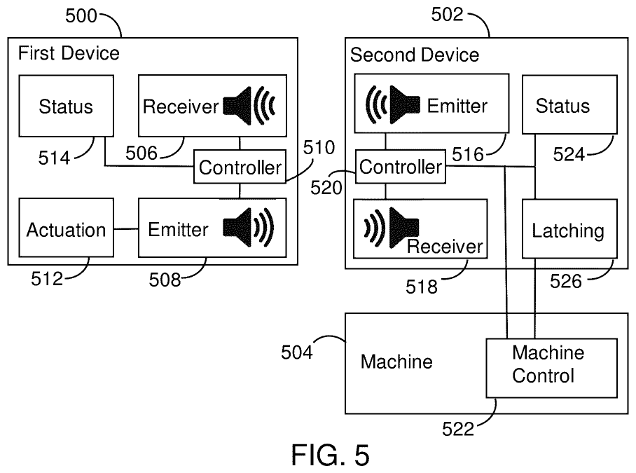

FIG. 4A schematically illustrates an operator 400 using a device 402 to alter (e.g., interrupt) operation of a machine 406, according to an illustrative embodiment. The operator 400 actuates an activation mechanism (e.g., blows into a mouthpiece, as shown and described below) of the device 402, which activates an emitter 404 (e.g., acoustic emitter or ultrasonic emitter) of the device 402 to produce a first acoustic signal (e.g., a functional signal). The first acoustic signal has a first tone and a second tone (e.g., a signature comprising at least two distinct ultrasonic tones). The first acoustic signal travels outward from the emitter 404 (e.g., in all directions or over a range of directions that includes a direction toward the machine 406), which is situated remotely from the machine 406. The machine 406 is equipped with another device 408 including a receiver 410 that is configured to receive the first acoustic signal. When the first acoustic signal is received at the machine 406, operation of the machine 406 is altered (e.g., the machine 406 is powered down outside the normal means of powering down, such as by latching a powered-off state until further deliberate action at the machine 406 as part of an emergency stop).

In some embodiments, the receiver 410 is configured to recognize the first tone and the second tone in the first acoustic signal (e.g., discriminate the first and second tones from other tones and/or ambient background noise). In some embodiments, the device 408 includes a controller (not shown separately in FIG. 4A) in communication with the receiver 410. The controller may be configured to alter operation of the machine based on receiving the first acoustic signal and/or discriminating the first tone and the second tone (e.g., from ambient signals in the environment). In some embodiments, the two tones are separated by a frequency range sufficient to distinguish the first from the second tone (e.g., a range of 10 Hz in the band 20 kHz-40 kHz or a range of 100 Hz in the band 80 kHz-150 kHz. In some embodiments, such a feature can help the effect of sound disturbances not to affect the distinction between tones. In some embodiments, the emitter 404 also produces a second acoustic signal (e.g., a control signal) having a third tone. The second acoustic signal may travel outward from the emitter 404 (e.g., in all directions or over a range of directions that includes a direction toward the operator 400). The second acoustic signal may confirm for the operator 400 that the device 402 is functioning properly (e.g., by producing an audible tone during and/or after actuation).

Although FIG. 4A illustrates one operator 400 using one device 402 to alter operation of one machine 406 based on one acoustic signal, other configurations are possible. For example, one device can be configured to alter multiple machines, provided that each machine is mounted with a device having a receiver that is configured to receive the first acoustic signal and take selective action based on discriminating one or more tones (e.g., a signature) carried by the first acoustic signal. In addition, multiple devices can be configured to alter operation of one machine, provided that each device is configured to produce a first acoustic signal having one or more similar tones. In some embodiments, multiple devices can be configured to alter operation of many machines, provided that each machine is mounted with a receiver that is configured to receive the first acoustic signal and take selective action based on discriminating the one or more similar tones. In addition, further possibilities are enabled by configuring each device to emit two or more functional signals. For example, a device can emit a first functional signal having a first tone and a second tone, and a second functional signal having a third tone and a fourth tone (that are different from and/or not resonant with the first tone and the second tone). In some embodiments, a single signal (e.g., a multi-carrier signal) can include all four tones. In some embodiments, a distinct signature can correspond to a unique robot, a unique kind of robot, a unique area of operation in an environment, or another feature (e.g., in the span of control).

In some embodiments, the device 402 is associated with a machine of interest (e.g., to prevent accidental and/or malicious misuse). For example, a unique signature can be determined for each individual machine based on a combination of unique tones (although many machines could be configured to receive the same signature). In some embodiments, the emitter 404 is configured to emit the emitted signal for at least a threshold number of periods (e.g., two, three, four, or another suitable number), or a minimum amount of time, regardless of the time the operator 400 prolongs the initial physical actuation. In some embodiments, the device 408 is configured to receive the signal for at least a threshold number of periods (e.g., two, three, four, or another suitable number), or a minimum amount of time, before operation of the machine 406 is altered.

In some embodiments, the device 402 is associated with a certain span of control. For situations in which the machine(s) whose operation is altered is not mobile, the device 402 can be associated with a spatial span of control (e.g., affecting machines within a certain spatial distance). Exemplary applications may include robotic arms that are fixed to the ground or automation machinery (e.g., all or part of one or more machines). For situations in which the machine(s) whose operation is altered is mobile, a spatial span of control may be associated with a further infrastructure to encode the signal (e.g., dynamically). For example, a mobile robot could change the encoding signature for received signals depending on its location, or infrastructure could be provided to store the signatures of signals (as opposed to on-robot storage of all available signals). In some embodiments, a mesh of relays or amplifiers spatially distributed over a region of interest can propagate the signal to cover a large area of interest (e.g., an entire facility, and/or one or more zones within the facility, such as aisles of a warehouse).

FIG. 4B schematically illustrates an operator using a device 402 to alter (e.g., interrupt) operation of multiple machines 406A and 406B, according to an illustrative embodiment.

The operator 400 actuates an activation mechanism of the device 402, which activates an emitter 404 of the device 402 to produce a first acoustic signal including a first tone and a second tone. The first acoustic signal travels outward from the emitter 404, which is situated remotely from the first machine 406A.

The first acoustic signal serves to alter operation of multiple machines in this example. For example, the first machine 406A is equipped with another device 408A including a receiver 410A that is configured to receive the first acoustic signal. When the first acoustic signal is received at the machine 406A, operation of the machine 406A is altered (e.g., the machine 406A is powered down outside the normal means of powering down, such as by latching a powered-off state until further deliberate action at the machine 406A as part of an emergency stop).

In this example, the first acoustic signal also serves to alter operation of the second machine 406B, which is equipped with another device 408B including a receiver 410B that is configured to receive the first acoustic signal. When the first acoustic signal is received at the machine 406B, operation of the machine 406B is altered (e.g., the machine 406B is powered down outside the normal means of powering down, such as by latching a powered-off state until further deliberate action at the machine 406B as part of an emergency stop).

Although the example depicts the acoustic signal being used to alter the operation of two machines, an acoustic signal can be used to alter the operation of any number of machines.

In this example, one or more relay units 407 are also included to allow the first acoustic signal to propagate over an increased range. Each of the relay units 407 can serve to relay the acoustic signal, such as by re-broadcasting the acoustic signal. Any number or configuration of the relay units 407 can be used.

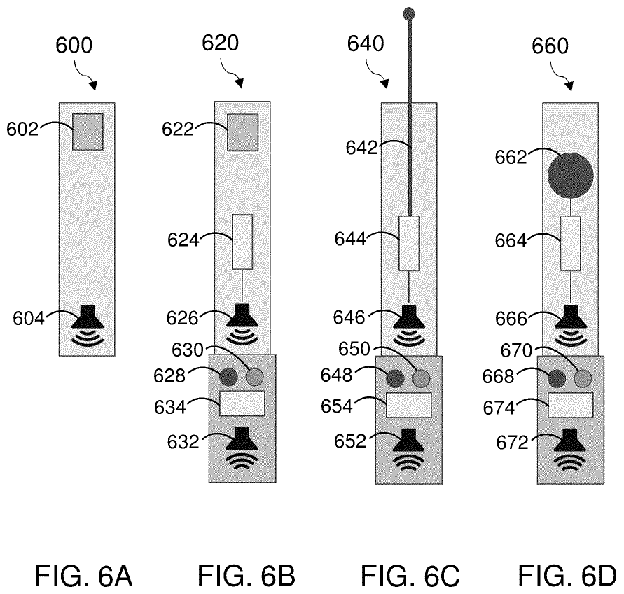

FIG. 5 illustrates a schematic of a first device 500 for altering operation of a machine 504 and a second device 502 for altering operation of the machine 504, according to an illustrative embodiment. The first device 500 is remote from the second device 502. The first device 500 may also be remote from the machine 504, and the second device 502 may be attached to (e.g., physically mounted and/or hardwired to) the machine 504, although one skilled in the art will appreciate that other embodiments are also possible. The first device includes a receiver 506, an emitter 508, a controller 510 in communication with the receiver 506 and the emitter 508, and an actuation mechanism 512 in communication with the emitter 508. The emitter 508 may be similar to the emitter 404 shown and described above in FIG. 4A and may provide a similar function. The actuation mechanism 512 may be similar to the actuation mechanism described in FIG. 4A and may provide a similar function. The receiver 506 may be similar to the receiver 410 shown and described above in FIG. 4A, but the receiver 506 is included on the first device 500 that is remote from the machine 504, and may provide a different function when implemented on the first device 500. For example, the receiver 506 may listen for a return signal emitted from the second device 502 (and/or the machine 504), e.g., to establish pairing and/or to provide additional assurances of correct interoperation of the first device 500, the second device 502, and/or the machine 504.

In some embodiments, the first device 500 also includes a status module 514. The status module 514 can confirm (e.g., for an operator of the device 500 and/or the machine 504) that the emitter 508 has or is successfully emitting a signal. In some embodiments, the status module 514 emits an audible acoustic signal and/or one or more visible light indicators. In some embodiments, the emitter 508 emits a signal for a minimum or predetermined amount of time (e.g., 10 seconds, 30 seconds, 60 seconds, 90 seconds, or another suitable time period which is sufficient, under the circumstances, to mitigate a risk of failing to receive the intended signal). In some embodiments, the emitter 508 stops emitting after receiving a feedback signal from the second device 502 and/or the machine 504.

The second device 502 includes an emitter 516, a receiver 518, and a controller 520 in communication with the emitter 516 and the receiver 518. These components can perform similar functions to the similar components included as part of the first device 500. During operation, the receiver 518 receives a first acoustic signal having a first tone and a second tone (e.g., from the first device 500). The controller 520 is configured to alter operation of the machine 504 based on the first acoustic signal. The controller 520 is in communication with a status module 524 and a latching module 526. The status module 524 can perform a similar function as the status module 514, such as confirming (e.g., for an operator of the device 500 and/or the machine 504) that the emitter 516 has or is successfully emitting a signal. In some embodiments, the status module 514 emits an audible acoustic signal and/or one or more visible light indicators.

The latching module 526 can implement a safety command received from the controller 520 (e.g., an emergency stop) in a predictable and/or controlled manner. For example, in an emergency stop situation, after the signal is received at the receiver 518, the signal for altering operation of the machine 504 must be sustained until a further time (e.g., a separate, deliberate action by a human being). The latching module 526 may provide a mechanism by which a received signal for any amount of time (e.g., above a minimum threshold of time to confirm reliable receipt of a signal) is sustained for a longer time. The controller 520 is also in communication with a machine control module 522 of the machine 504. In this manner, the controller 520 has a means of direct communication with the machine 504 (e.g., to issue a functional command, such as “start”, “stand by”, “assume a default pose” or “migrate to a specified location”, in addition to the safety command mediated by the latching module 526).

In some embodiments, the first device 500 determines a proximity of the machine 504 and/or second device 502 based on a loss of magnitude of the return signal relative to a specified origination power of the return signal.

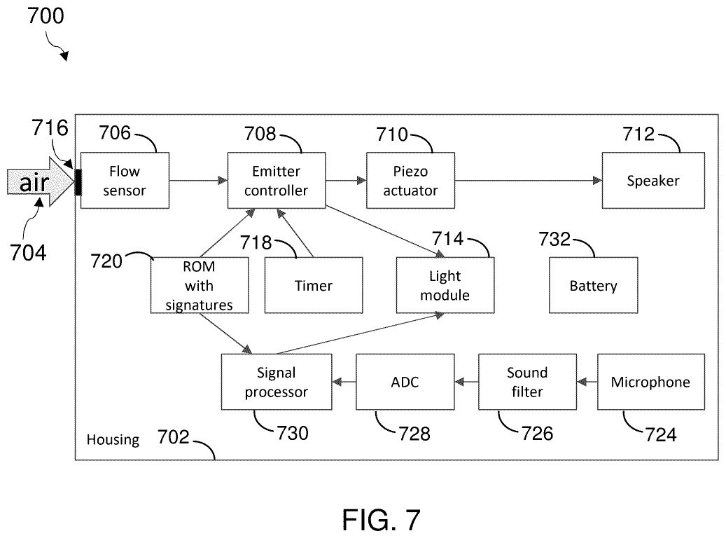

FIGS. 6A-6D illustrate schematics of four devices 600, 620, 640, 660 for altering operation of a machine, each having different actuation mechanisms, according to illustrative embodiments. FIG. 6A shows a device 600 having a “blow-mechanical” actuation mechanism. The device 600 includes an activation mechanism 602, which can include a mouthpiece having one or more openings (e.g., a fluid inlet and/or outlet) and/or an air chamber. When an operator actuates the activation mechanism 602 (e.g., by blowing into the mouthpiece), an emitter 604 can produce one or more acoustic signals, each having one or more tones (e.g., as shown and described above in FIGS. 4-5). In some embodiments, the device 600 can be sufficient to send a distributed signal (e.g., to an area or a volume surrounding the emitter 600) corresponding to a predefined action of the machine whose operation is altered (e.g., go to a default pose or mode, standby etc.), with no need to receive any feedback from the machine. In some embodiments, the activation mechanism 602 is formed integrally with the emitter 604 (e.g., in one molded plastic piece having a mouthpiece on one end and an air egress on an opposite end).

FIG. 6B shows a schematic of a device 620 for altering operation of a machine having a “blow-electronic” actuation mechanism, according to an illustrative embodiment. The device 620 includes an activation mechanism 622, which, like the activation mechanism 602, can be a mouthpiece having one or more openings and/or an air chamber. When an operator actuates the activation mechanism 622, an intermediate mechanism (e.g., a sensor and/or a signal converter) 624 can sense a characteristic corresponding to actuation of the activation mechanism 622 (e.g., a change in flow or air pressure), and can produce a signal that, in turn, triggers the emitter 626 to produce one or more acoustic signals, each having one or more tones (e.g., for functional and/or control purposes, as shown and described above). In some embodiments, the emitter 626 can emit one or more acoustic signals for a minimum emitting time (e.g., one second, two seconds, three seconds, or another duration) regardless of the duration of the actuation (as long as the initial actuation was sufficiently sensed to trigger the emitter 626). In some embodiments, the emitter 626 can automatically unlatch (e.g., in non-emergency stop implementations, where a human being is not required to reset the machine by deliberate action). For example, in certain situations, it may be acceptable for a machine to acknowledge reception of the signal and proceed, such as with an instruction to resume motion or temporarily halt for a predefined amount of time.

In some embodiments, the device 620 may include other electronic components to support one or more other functionalities. For example, one or more indicator lights 628, 630 can be included to provide indicators of other functions being successfully performed. As on example, indicator light 628 can turn on (or blink, or provide another visible indication) to confirm that the emitter 626 is emitting, and can turn off (or stop blinking, or provide another visible indication) to confirm that the emitter 626 is not emitting (and/or upon resetting). As another example, light 630 can turn on to confirm that it has paired with one or more machines whose operation the device 620 is configured to alter. In some embodiments, the device 620 can pair with one or more machines using an embedded receiver 632. The receiver 632 can be configured to receive a return signal from the one or more machines whose operation the device 620 is configured to alter. In some embodiments, a controller 634 provides logic for supporting different functions, e.g., encoding different signals and/or interpreting feedback or return signals.

FIG. 6C shows a schematic of another device 640 for altering operation of a machine, according to an illustrative embodiment. The device 640 includes several components that are similar to the devices 600 and/or 620, including an intermediate mechanism 644, an emitter 646, indicator lights 648, 650, a receiver 652, and a controller 654. However, the device 640 includes a different activation mechanism 642, which includes a different means of actuation (e.g., a pull cord, as shown). The activation mechanism 642 can be in mechanical and/or electrical contact (e.g., direct and/or indirect contact) with the intermediate mechanism 644, and can act on the intermediate mechanism 644 to achieve a similar result as when the intermediate mechanism 624 is acted upon. In some embodiments, the device 640 can be attached to a vest through the activation mechanism 642. When a user moves (e.g., pulls) the activation mechanism 642, it can act on the intermediate mechanism 644 to generate a signal. In some embodiments, the device 640 is attached directly to a vest, and a user can pull the activation mechanism 642 in an emergency. In some embodiments, the device 640 may be used as a wearable device and/or when the activation of the device 640 is facilitated by a manual pulling action (e.g., when the device 640 is a shape that is easy to grab and/or pull in an emergency).

FIG. 6D shows a schematic of another device 660 for altering operation of a machine, according to an illustrative embodiment. The device 660 includes components that are similar to the device 640, including an intermediate mechanism 664, an emitter 666, indicator lights 668, 670, a receiver 672, and a controller 674. However, the device 660 includes a different activation mechanism 662, which includes a different means of actuation (e.g., a push button, as shown). The activation mechanism 662 can be in mechanical and/or electrical contact with (e.g., hard wired to) the intermediate mechanism 664, and can act on the intermediate mechanism 664 to achieve a similar result as when the intermediate mechanisms 624, 644 are acted upon. In some embodiments, the device 660 may be attached to a structural element of an environment (e.g., a wall, post or panel) or part of machinery or safeguards capable of solid mounting, so that the activation mechanism 662 can be pressed by a user. In some embodiments, the activation mechanism 662 is a prominent feature of the device 660 so that it may be easily reachable and/or activated immediately without hindrance. In some embodiments, the device 660 can be handheld, with the activation mechanism 662 capable of being engaged pressing, pushing, squeezing and/or compressing.

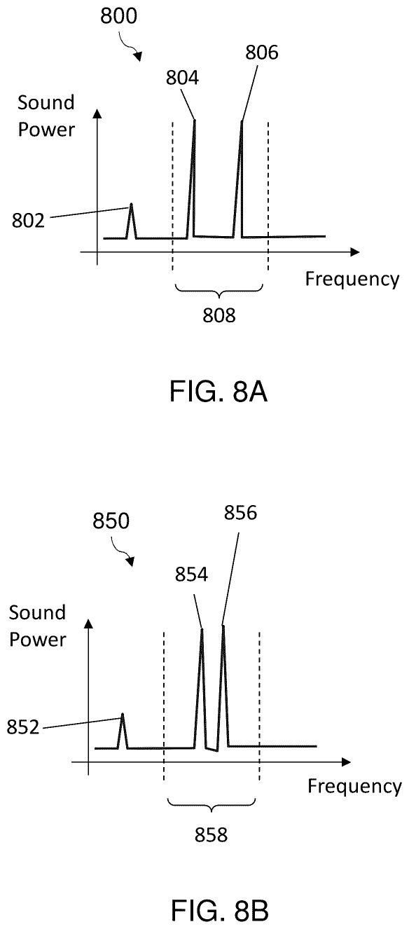

FIG. 7 illustrates a schematic of an exemplary device 700 for altering operation of a machine, according to an illustrative embodiment. The device 700 includes a housing 702, which has a feature 716 (e.g., mouthpiece, opening, depression, extrusion, or other suitable geometry) for receiving or permitting the flow of air 704. In one embodiment, the feature 716 is a blow feature that operates mechanically or electromechanically. During operation, when air 704 flows into (and/or past, around, or within) the feature 702, a flow sensor 706 detects a change in air flow or pressure, and outputs a signal to an emitter controller 708. The emitter controller 708 processes the received signal and outputs a processed signal to a piezo actuator 710, which converts the electrical signal into a mechanical displacement (e.g., a periodic vibration). The piezo actuator 710 is in communication with a speaker 712, which produces an acoustic signal (e.g., a functional signal having one or more tones, as shown and described above) that propagates through a fluid medium (e.g., air).

In some embodiments, the emitter controller 708 is in electrical communication with read-only memory (ROM) 720 that stores one or more signatures that the emitter controller 708 uses to output a signal including the correct tones. In some embodiments, the device 700 includes a timer 718, which can be used as a system clock for timing one or more system functions (e.g., generating a time-dependent signal). In some embodiments, the device 700 includes a light module 714, which may include one or more individual lights and/or a separate controller. During operation, the emitter controller 708 may output a signal to the light module 714 (e.g., to turn one or more lights on, or to provide another visual indication, to signal that the device 700 is responding properly to air flow 704).

The device 700 also includes a microphone 724. During operation, the microphone 724 may receive ambient sounds and/or convert them into one or more electrical signals (e.g., a continuously input analog signal), which are passed onto a sound filter 726. The sound filter 726 can filter out certain frequencies that are not of interest (e.g., any frequencies outside of a band relevant to one or more pairing signals provided by a relevant machine). The sound filter 726 can then pass on (e.g., output) a filtered signal (e.g., a filtered analog signal) to an analog-to-digital converter (ADC) 728. The ADC 728 can process the filtered signal to create a processed filtered signal (e.g., a digital signal), which can also be passed onto the signal processor 730, which in turn can control the light module 714 (e.g., to turn one or more lights on, or to provide another visual indication, to signal that the device 700 is responding properly to any relevant frequencies of interest in the environment). The signal processor 730 can detect the presence of frequencies in the signature present in the incoming filtered signal. The signal processor 730 can also rely on ROM 720 (or another separate ROM module, not shown) to store one or more signatures that the signal processor 730 can use to determine when to output a signal to the light module 714 (e.g., indicating when a frequency in the environment matching the stored signatures is heard). A battery 732 can be included on board to power one or more of the above-described electronic components, e.g., as needed during operation.

Although the components shown and described in FIG. 7 are connected in a certain order and provide certain functions, one having ordinary skill in the art will appreciate that other orders of connection and/or other combinations of components may provide similar functions (e.g., the same functions at the overall system level). For example, in some embodiments, the functions of the piezo actuator 710 and the speaker 712 can be included in one modular component that is capable of receiving a signal from the emitter controller 708 and producing a sound. As another example, in some embodiments, the emitter controller 708 can include a timing function, such that a separate timer 718 is not needed. In some embodiments, the sound filter 726, ADC 728, and/or signal processor 730 can be included in a single microcontroller or chip. Other embodiments, alterations or substitutions may be made without departing from the spirit or scope of the invention.

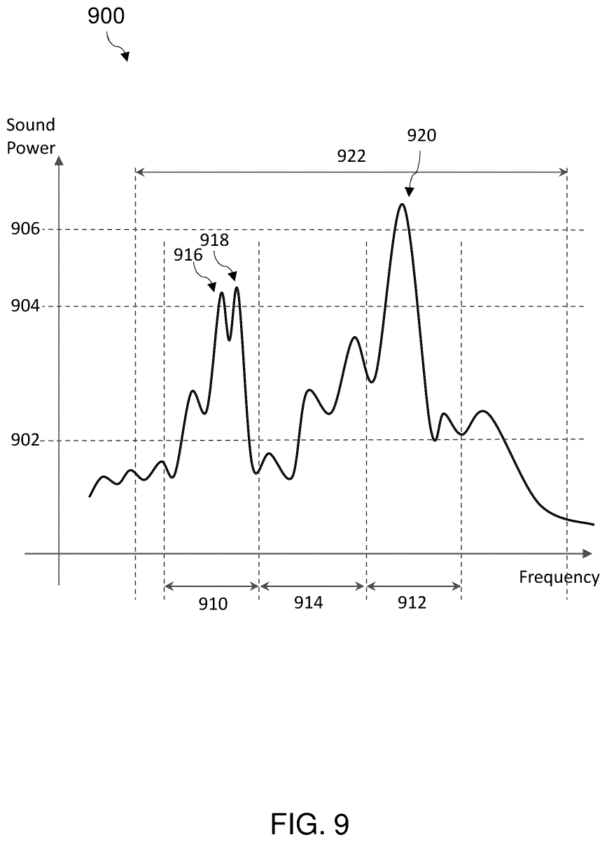

FIGS. 8A-8B schematically illustrate exemplary signals 800, 850 produced by a device for altering operation of a machine (e.g., as shown and described above in FIGS. 4-7), according to an illustrative embodiment. The signal 800 is plotted on a graph showing sound power (on the vertical or y-axis) as a function of frequency (on the horizontal or x-axis). The signal 800 may include certain audible feedback, such as the audible feedback represented by the frequency peak 802. The signal 800 also includes certain tones, such as a first tone 804 and a second tone 806 (e.g., that define a signature). The tones 804, 806 may each fall within the frequency band 808, which may represent a permitted range for one or more functional tones. When such a signal is emitted by a device for altering operation of a machine, it may be received by the machine, and the machine's operation may be altered (e.g., interrupted) based on the set of tones or signature present in the signal, as shown and described above in FIGS. 4-7. In some embodiments, the frequency peak 802 is in the audio frequency range while the first tone 804 and the second tone 806 are in the ultrasonic frequency range. The signal 850 in FIG. 8B includes similar components, including audible feedback 852, a first tone 854, a second tone 856, and a frequency range 858 that constitute a different signature than the one depicted in FIG. 8A using similar bands (e.g., 808 and 858). In some embodiments, the devices described herein are configured with band filtering, which is applied to frequencies on one or both sides of the frequency band 808 or 858.

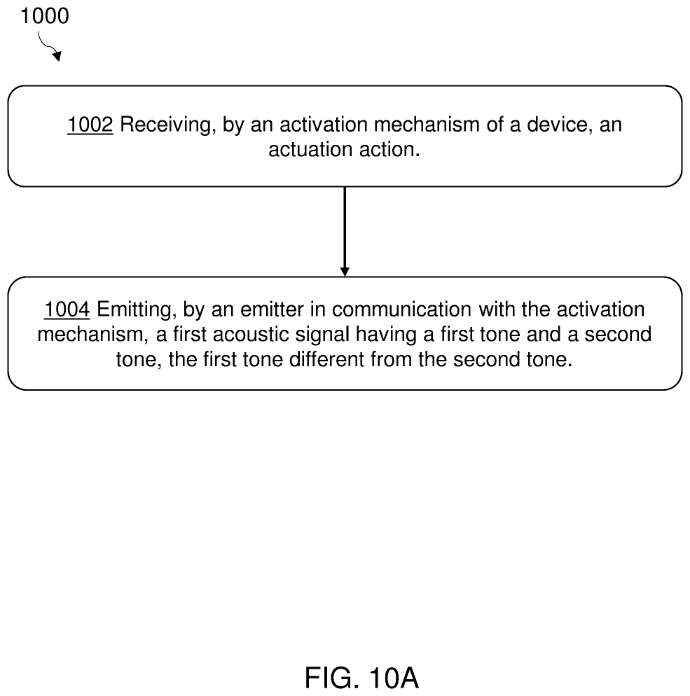

FIG. 9 schematically illustrates a unique signature 900 carried by a signal produced by a device for altering operation of a machine, according to an illustrative embodiment. Similar to the signals 800 and 850, the unique signature 900 is also plotted on a graph showing sound power (on the vertical or y-axis) as a function of frequency (on the horizontal or x-axis). Several threshold levels are depicted on both the sound power and the frequency axes. On the sound power axis, a background noise threshold 902, a minimum sound power level 904 (e.g., to detect a tone), and a recommended safety limit 906 (e.g., for noise hazards) are shown. On the frequency axis, a first tolerance band 910, a second tolerance band 912, a minimum separation band 914 (e.g., between nominal tones), and an available band 922 are shown. The first tolerance band 910 specifies a range of frequencies within which a sound power level for one or more frequencies meeting or exceeding the minimum sound power level 904 may be registered as a single tone. For example, the two peaks 916, 918 within the first tolerance band 910 may be registered as tone 1. Similarly, the peak 920 may be registered as tone 2 (although note that tone 2 has exceeded the recommended safety limit and should be decreased accordingly). A signature may be defined by the combination of tones (e.g., with the first tone associated with the peaks 916, 918 and the second tone associated with the peak 920). The bands 910, 912, 914, and/or 922 may be tuned by a signal processor (e.g., the signal processor 730 shown and described above in FIG. 7) as part of signal filtering.

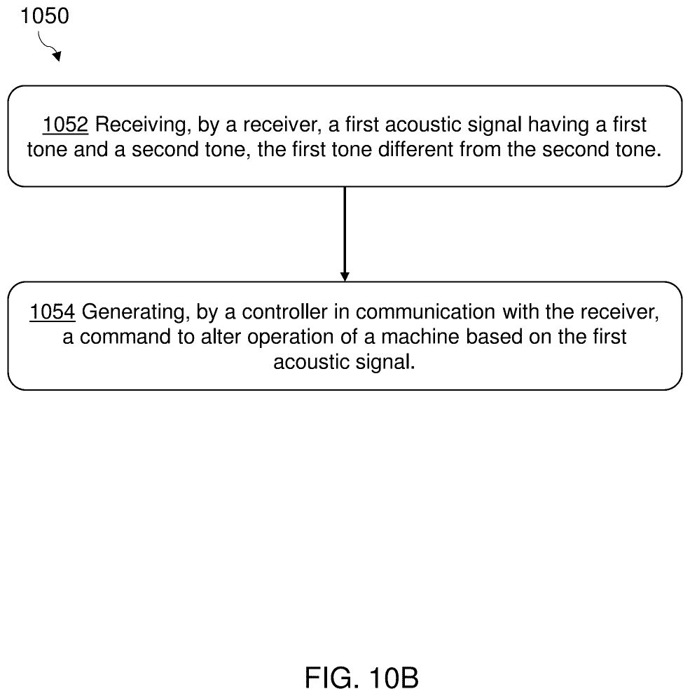

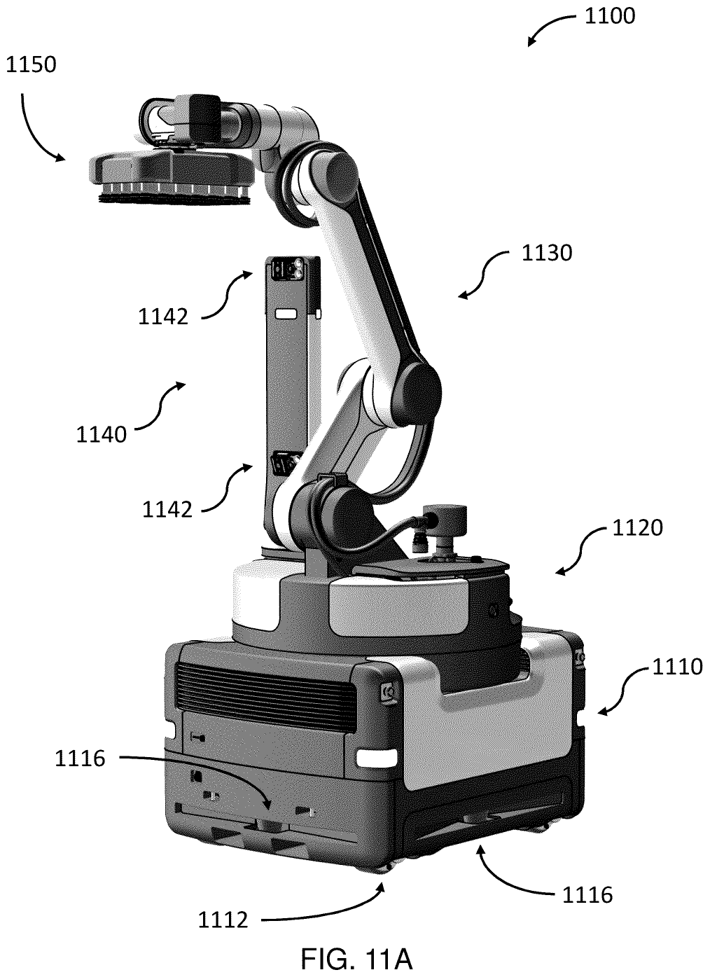

FIG. 10A is a flowchart of an exemplary method 1000 for altering operation of a machine (e.g., the machine 406 shown and described above), according to an illustrative embodiment. In a first step 1002, an actuation action is received by an activation mechanism of a device (e.g., the activation mechanisms 602, 622, 642, and/or 662, as shown in FIGS. 6A-6D and described above). In a second step 1004, an emitter in communication with the activation mechanism emits a first acoustic signal having a first tone and a second tone, the first tone different (e.g., in frequency) from the second tone.

FIG. 10B is a flowchart of an exemplary method 1050 for altering operation of a machine (e.g., the machines 406 and/or 504 shown in FIGS. 4 and 5 and described above), according to an illustrative embodiment. In a first step 1052, a first acoustic signal having a first tone and a second tone, the first tone different from the second tone, is received by a receiver (e.g., the receiver 410, as shown and described above). In a second step 1054, a command to alter operation of a machine (e.g., the machine 406, as shown and described above) based on the first acoustic signal is generated by a controller in communication with the receiver.

In this section, an overview of some components of one embodiment of a highly integrated mobile manipulator robot configured to perform a variety of tasks is provided to explain the interactions and interdependencies of various subsystems of the robot. Each of the various subsystems, as well as control strategies for operating the subsystems, are described in further detail in the following sections.

Robots can be configured to perform a number of tasks in an environment in which they are placed. Exemplary tasks may include interacting with objects and/or elements of the environment. Notably, robots are becoming popular in warehouse and logistics operations. Before robots were introduced to such spaces, many operations were performed manually. For example, a person might manually unload boxes from a truck onto one end of a conveyor belt, and a second person at the opposite end of the conveyor belt might organize those boxes onto a pallet. The pallet might then be picked up by a forklift operated by a third person, who might drive to a storage area of the warehouse and drop the pallet for a fourth person to remove the individual boxes from the pallet and place them on shelves in a storage area. Some robotic solutions have been developed to automate many of these functions. Such robots may either be specialist robots (i.e., designed to perform a single task or a small number of related tasks) or generalist robots (i.e., designed to perform a wide variety of tasks). To date, both specialist and generalist warehouse robots have been associated with significant limitations.

For example, because a specialist robot may be designed to perform a single task (e.g., unloading boxes from a truck onto a conveyor belt), while such specialized robots may be efficient at performing their designated task, they may be unable to perform other related tasks. As a result, either a person or a separate robot (e.g., another specialist robot designed for a different task) may be needed to perform the next task(s) in the sequence. As such, a warehouse may need to invest in multiple specialized robots to perform a sequence of tasks, or may need to rely on a hybrid operation in which there are frequent robot-to-human or human-to-robot handoffs of objects.

In contrast, while a generalist robot may be designed to perform a wide variety of tasks (e.g., unloading, palletizing, transporting, depalletizing, and/or storing), such generalist robots may be unable to perform individual tasks with high enough efficiency or accuracy to warrant introduction into a highly streamlined warehouse operation. For example, while mounting an off-the-shelf robotic manipulator onto an off-the-shelf mobile robot might yield a system that could, in theory, accomplish many warehouse tasks, such a loosely integrated system may be incapable of performing complex or dynamic motions that require coordination between the manipulator and the mobile base, resulting in a combined system that is inefficient and inflexible.

Typical operation of such a system within a warehouse environment may include the mobile base and the manipulator operating sequentially and (partially or entirely) independently of each other. For example, the mobile base may first drive toward a stack of boxes with the manipulator powered down. Upon reaching the stack of boxes, the mobile base may come to a stop, and the manipulator may power up and begin manipulating the boxes as the base remains stationary. After the manipulation task is completed, the manipulator may again power down, and the mobile base may drive to another destination to perform the next task.

In such systems, the mobile base and the manipulator may be regarded as effectively two separate robots that have been joined together. Accordingly, a controller associated with the manipulator may not be configured to share information with, pass commands to, or receive commands from a separate controller associated with the mobile base. As such, such a poorly integrated mobile manipulator robot may be forced to operate both its manipulator and its base at suboptimal speeds or through suboptimal trajectories, as the two separate controllers struggle to work together. Additionally, while certain limitations arise from an engineering perspective, additional limitations must be imposed to comply with safety regulations. For example, if a safety regulation requires that a mobile manipulator must be able to be completely shut down within a certain period of time when a human enters a region within a certain distance of the robot, a loosely integrated mobile manipulator robot may not be able to act sufficiently quickly to ensure that both the manipulator and the mobile base (individually and in aggregate) do not threaten the human. To ensure that such loosely integrated systems operate within required safety constraints, such systems are forced to operate at even slower speeds or to execute even more conservative trajectories than those limited speeds and trajectories as already imposed by the engineering problem. As such, the speed and efficiency of generalist robots performing tasks in warehouse environments to date have been limited.

In view of the above, a highly integrated mobile manipulator robot with system-level mechanical design and holistic control strategies between the manipulator and the mobile base may provide certain benefits in warehouse and/or logistics operations. Such an integrated mobile manipulator robot may be able to perform complex and/or dynamic motions that are unable to be achieved by conventional, loosely integrated mobile manipulator systems. As a result, this type of robot may be well suited to perform a variety of different tasks (e.g., within a warehouse environment) with speed, agility, and efficiency.

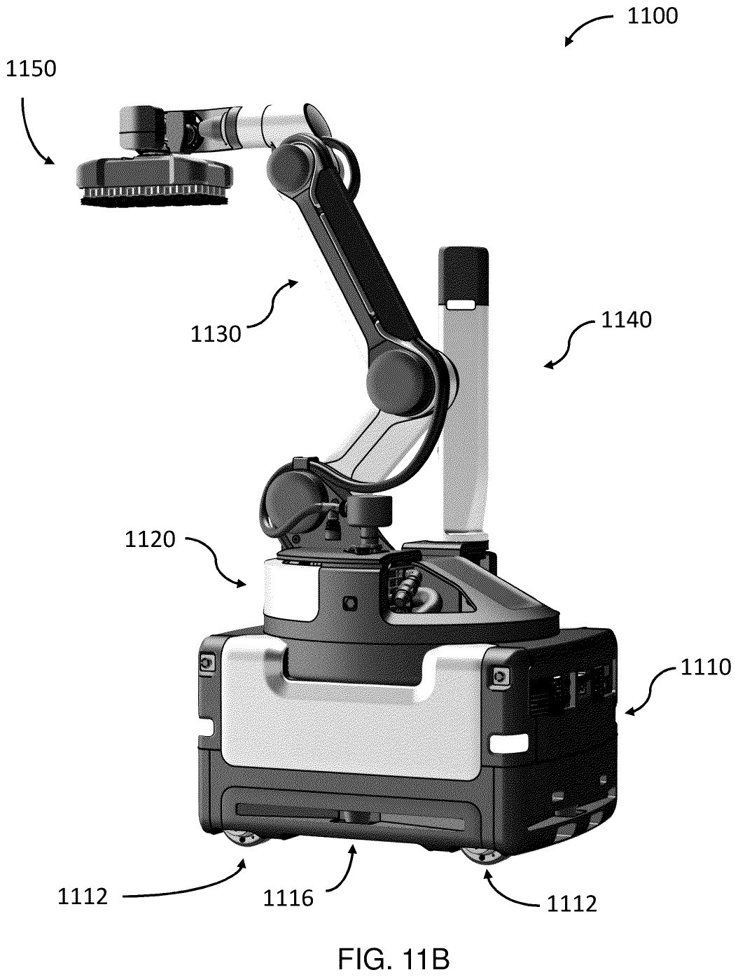

FIGS. 11A and 11B are perspective views of a robot 1100, according to an illustrative embodiment of the invention. The robot 1100 includes a mobile base 1110 and a robotic arm 1130. The mobile base 1110 includes an omnidirectional drive system that enables the mobile base to translate in any direction within a horizontal plane as well as rotate about a vertical axis perpendicular to the plane. Each wheel 1112 of the mobile base 1110 is independently steerable and independently drivable. The mobile base 1110 additionally includes a number of distance sensors 1116 that assist the robot 1100 in safely moving about its environment. The robotic arm 1130 is a 6 degree of freedom (6-DOF) robotic arm including three pitch joints and a 3-DOF wrist. An end effector 1150 is disposed at the distal end of the robotic arm 1130. The robotic arm 1130 is operatively coupled to the mobile base 1110 via a turntable 1120, which is configured to rotate relative to the mobile base 1110. In addition to the robotic arm 1130, a perception mast 1140 is also coupled to the turntable 1120, such that rotation of the turntable 1120 relative to the mobile base 1110 rotates both the robotic arm 1130 and the perception mast 1140. The robotic arm 1130 is kinematically constrained to avoid collision with the perception mast 1140. The perception mast 1140 is additionally configured to rotate relative to the turntable 1120, and includes a number of perception modules 1142 configured to gather information about one or more objects in the robot's environment. The integrated structure and system-level design of the robot 1100 enable fast and efficient operation in a number of different applications.

A device can be used to alter the robot 1100 in accordance with the teachings herein. For example, the device can emit an acoustic signal having a first tone and a second tone. Additionally, in response to the robot 1100 receiving the acoustic signal, the operation of the robot 1100 can be interrupted, for instance, by stopping and/or starting operation of the mobile base 1110 and/or the robotic arm 1130.

A number of implementations have been described. Nevertheless, it will be understood that various modifications may be made without departing from the spirit and scope of the disclosure.

What is claimed is:

1. A device comprising:
an emitter configured to produce a first acoustic signal having a first tone and a second tone, the first tone different from the second tone, the first acoustic signal operable to alter operation of a machine receiving the first acoustic signal; and
an activation mechanism in communication with the emitter, the activation mechanism configured to activate the emitter.

2. The device of claim 1, wherein the device is located remotely from the machine.

3. The device of claim 1, wherein altering operation of the machine comprises interrupting operation of the machine.

4. The device of claim 1, wherein altering operation of the machine comprises stopping and/or starting operation of the machine.

5. The device of claim 1, wherein altering operation of the machine comprises initiating an emergency stop of the machine.

6. The device of claim 1, wherein altering operation of the machine comprises electrically separating from the machine one or more sources of power to the machine.

7. The device of claim 1, wherein the first tone has a frequency between 20 kHz and 2000 kHz and the second tone has a frequency between 20 kHz and 2000 kHz.

8. The device of claim 1, wherein the emitter is further configured to produce a second acoustic signal having a third tone.

9. The device of claim 8, wherein the third tone has a frequency between 300 Hz and 20 kHz.

10. The device of claim 1, wherein the machine comprises a robot.

11. The device of claim 1, wherein the activation mechanism comprises a blow mechanical feature.

12. The device of claim 1, wherein the activation mechanism comprises a blow electromechanical feature.

13. The device of claim 1, wherein the activation mechanism comprises a pull cord and/or a push button.

14. The device of claim 1, wherein the device further comprises a receiver configured to receive a return signal from the machine.

15. The device of claim 14, wherein the return signal comprises a periodic control signal, a pairing signal, or an acknowledgement signal.

16. The device of claim 14, wherein the device is configured to determine a proximity of the machine based on a loss of magnitude of the return signal relative to a specified origination power of the return signal.

17. The device of claim 1, wherein the device is configured to alter operation of two or more machines.

18. The device of claim 1, wherein the device is configured to alter operation of one uniquely identified machine.

19. The device of claim 1, wherein the device is embodied in a remote control device of the machine.

20. The device of claim 1, wherein the machine is configured to be altered based on a location of the machine relative to the device.

21. The device of claim 1, further comprising a signal processor configured to determine a nominal frequency of the first tone.

22. A device for altering operation of a machine, the device comprising:
a receiver configured to recognize a first acoustic signal having a first tone and a second tone, the first tone different from the second tone; and
a controller in communication with the receiver, the controller configured to alter operation of the machine based on the first acoustic signal.

23. The device of claim 22 wherein alteration of operation of the machine based on the first acoustic signal is maintained until the device receives a separate action.

24. A system for altering operation of a machine, the system comprising:
a first device for altering operation of a machine, the first device comprising
an emitter configured to produce a first acoustic signal having a first tone and a second tone, the first tone different from the second tone; and
an activation mechanism in communication with the emitter, the activation mechanism configured to activate the emitter; and
a second device for altering operation of the machine, the second device comprising
a receiver configured to recognize the first acoustic signal; and
a controller in communication with the receiver, the controller configured to alter operation of the machine based on the receiver recognizing the first acoustic signal.

25. The system of claim 24, further comprising one or more relay units configured to propagate the first acoustic signal over an increased range.
